(19) United States
(12) Patent Application Publication
(10) Pub. No.: US 2026/0175672 A1
(43) Pub. Date: Jun. 25, 2026

(54) VEHICLE PROTECTION MEMBER

(71) Applicants: TOYOTA JIDOSHA KABUSHIKI KAISHA, Toyota-shi Aichi-ken (JP); Kojima Industries Corporation, Toyota-shi Aichi (JP)

(72) Inventors: Katsuichiro HIRAKAWA, Toyota-shi Aichi-ken (JP); Yoshifumi NISHIO, Okazaki-shi Aichi-ken (JP); Takahiro IMAEDA, Toyota-shi Aichi-ken (JP); Takahiro OGIHARA, Toyota-shi Aichi-ken (JP); Seiji ARIOKA, Toyota-shi Aichi-ken (JP)

(73) Assignees: TOYOTA JIDOSHA KABUSHIKI KAISHA, Toyota-shi Aichi-ken (JP); Kojima Industries Corporation, Toyota-shi Aichi (JP)

(21) Appl. No.: 19/429,131

(22) Filed: Dec. 22, 2025

(30) Foreign Application Priority Data
Dec. 24, 2024 (JP) 2024-227993

(51) Int. Cl. B60K 11/04

(52) U.S. Cl. CPC B60K 11/04

(57) ABSTRACT

A vehicle protection member includes a flat main body affixed to a radiator lower end and projecting frontward. Multiple lateral ribs, spaced in the fore-aft direction and extending in the width direction, are formed on at least one of the upper or lower surfaces of the main body. Multiple longitudinal ribs, spaced in the width direction and extending fore-aft, interconnect adjacent lateral ribs. The main body defines a first reinforcing region in which longitudinal ribs on opposite sides of a lateral rib are aligned and the lateral-rib spacing exceeds the longitudinal-rib spacing, and a second reinforcing region, disposed in front of the first region, in which the longitudinal ribs are offset from each other and the lateral-rib spacing is less than the longitudinal-rib spacing.

### CROSS-REFERENCE TO RELATED APPLICATION

This application is based on and claims priority under 35 USC 119 from Japanese Patent Application No. 2024-227993 filed on Dec. 24, 2024, the disclosure of which is incorporated by reference herein.

### BACKGROUND

### Technical Field

The present disclosure relates to a vehicle protection member.

### Related Art

Japanese Patent Application Laid-Open (JP-A) No. 2009-269564 discloses a lower guard that extends frontward from below a bumper member. A plurality of front and rear ribs and lateral ribs are formed at a lower face of the lower guard.

However, in a case in which the lower guard is formed with a strength capable of withstanding road surface interference, there is a possibility that pedestrian protection performance may be reduced.

### SUMMARY

An object of the present disclosure is to obtain a vehicle protection member that is capable of suppressing breakage during road surface interference, while ensuring pedestrian protection performance.

A vehicle protection member of a first aspect includes: a flat plate-shaped main body portion that is attached to a lower end portion of a radiator and that extends out toward a vehicle front side from the radiator; plural lateral ribs that are provided at at least one of an upper face or a lower face of the main body portion, that are formed at a spacing in a vehicle front-rear direction, and that each extend in a vehicle width direction; and plural longitudinal ribs that are formed at a spacing in the vehicle width direction and that each extend in the vehicle front-rear direction to connect between adjacent lateral ribs, wherein the main body portion includes a first reinforcing structure portion at which positions of longitudinal ribs that are adjacent to each other in the vehicle front-rear direction with a lateral rib interposed therebetween coincide with each other, and a second reinforcing structure portion that is disposed at a front side of the first reinforcing structure portion such that positions of longitudinal ribs that are adjacent to each other in the vehicle front-rear direction with a lateral rib interposed therebetween are different from each other, in the first reinforcing structure portion, a spacing between the lateral ribs is greater than a spacing between the longitudinal ribs, and, in the second reinforcing structure portion, a spacing between the lateral ribs is smaller than a spacing between the longitudinal ribs.

The vehicle protection member of the first aspect includes the flat plate-shaped main body portion that is attached to the lower end portion of the radiator, and the main body portion extends out toward the vehicle front side from the radiator. Further, the lateral ribs and the longitudinal ribs are formed at at least one of the upper face or the lower face of the main body portion, and the longitudinal ribs connect between adjacent lateral ribs. In this regard, the main body portion includes the first reinforcing structure portion at which positions of longitudinal ribs that are adjacent to each other in the vehicle front-rear direction with a lateral rib interposed therebetween coincide with each other. That is to say, in the first reinforcing structure portion, since the ribs are disposed with the lateral ribs and the longitudinal ribs being in a lattice shape, rigidity of the main body portion is high, and breakage during road surface interference can be suppressed.

Further, the second reinforcing structure portion that is disposed at the front side of the first reinforcing structure portion such that positions of longitudinal ribs that are adjacent to each other in the vehicle front-rear direction with a lateral rib interposed therebetween are different from each other is provided. In the first reinforcing structure portion, the spacing between the lateral ribs is greater than the spacing between the longitudinal ribs, and, in the second reinforcing structure portion, the spacing between the lateral ribs is smaller than the spacing between the longitudinal ribs. Consequently, in the second reinforcing structure portion, since regions surrounded by the lateral ribs and the longitudinal ribs in plan view have substantially rectangular shapes with length directions thereof being along the vehicle width direction, and since positions of the longitudinal ribs at the front and rear are different from each other, the lateral ribs are more easily deformed to absorb energy when a pedestrian comes in contact therewith, and pedestrian protection performance can be maintained.

A vehicle protection member of a second aspect is the vehicle protection member of the first aspect, wherein the spacing between the lateral ribs in the second reinforcing structure portion is smaller than the spacing between the lateral ribs in the first reinforcing structure portion, and the spacing between the longitudinal ribs in the second reinforcing structure portion is greater than the spacing between the longitudinal ribs in the first reinforcing structure portion.

In the vehicle protection member of the second aspect, the spacing between the lateral ribs in the second reinforcing structure portion is smaller than the spacing between the lateral ribs in the first reinforcing structure portion. On the other hand, the spacing between the longitudinal ribs in the second reinforcing structure portion is greater than the spacing between the longitudinal ribs in the first reinforcing structure portion. Consequently, the second reinforcing structure portion is more easily warped toward the vehicle upper side than the first reinforcing structure portion, and pedestrian protection performance is improved.

A vehicle protection member of a third aspect is the vehicle protection member of the first aspect, wherein a radiator support portion including a region in which ribs are disposed in a truss shape in plan view is provided further toward a vehicle rear side than the first reinforcing structure portion, and the radiator is attached to the radiator support portion.

In the vehicle protection member of the third aspect, the radiator support portion is provided further toward the vehicle rear side than the first reinforcing structure portion, and the radiator support portion is configured by the ribs, which are disposed in a truss shape in plan view, whereby the radiator support portion can be rigidly configured, and falling-off of the main body portion from the radiator can be suppressed.

A vehicle protection member of a fourth aspect is the vehicle protection member of the first aspect, wherein slits are respectively formed at both vehicle width direction end sides of the main body portion.

In the vehicle protection member of the fourth aspect, the slits are formed at both vehicle width direction end sides of the main body portion, thereby enabling a region between the slits to be more easily warped.

As explained above, the vehicle protection member according to the present disclosure enables breakage to be suppressed during road surface interference, while ensuring pedestrian protection performance.

### BRIEF DESCRIPTION OF THE DRAWINGS

An exemplary embodiment of the present disclosure will be described in detail based on the following figures, wherein:

FIG. 1 is a schematic perspective view schematically illustrating a front portion of a vehicle to which a vehicle protection member according to an exemplary embodiment is applied;

FIG. 2 is a schematic side cross-sectional view of the vehicle to which the vehicle protection member according to the exemplary embodiment is applied; and

FIG. 3 is a bottom view of the vehicle protection member according to the exemplary embodiment.

### DETAILED DESCRIPTION

A vehicle protection member according to an exemplary embodiment will be explained, with reference to the drawings.

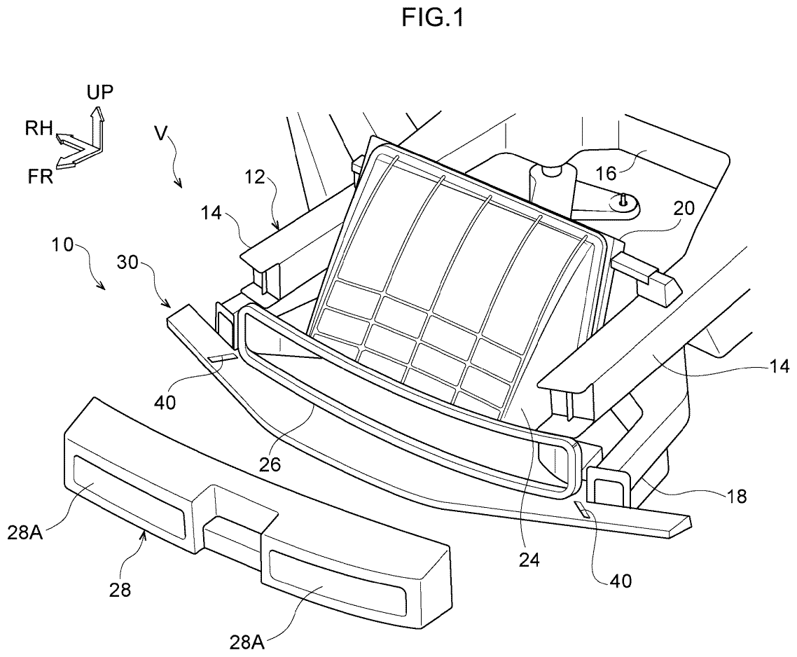

FIG. 1 is a schematic perspective view schematically illustrating a front portion of a vehicle V to which the vehicle protection member according to the exemplary embodiment is applied. It should be noted that, in the drawings, arrow FR, arrow UP, and arrow RH respectively indicate a vehicle frontward direction, a vehicle upward direction, and a vehicle leftward direction of the vehicle V. Unless specifically stated otherwise, in cases in which front and rear, up and down, and left and right directions are used in the following explanation, they respectively indicate front and rear in a vehicle front-rear direction, up and down in a vehicle up-down direction, and left and right in a vehicle left-right direction (width direction).

As illustrated in FIG. 1, the vehicle V includes a front frame portion 12 that is formed by casting. The front frame portion 12 is a frame member that is integrally formed by casting, including front side portions 14 and a dash cross portion 16.

The front side portions 14 are provided in a left and right pair and each extend in the vehicle front-rear direction. Further, rear end portions of the front side portions 14 are connected to each other at the left and right by the dash cross portion 16. Furthermore, a front pillar lower portion, which is not illustrated in the drawings, is provided at a rear portion of each of the front side portions 14.

A suspension member 18 is disposed below the front side portions 14, and a lower guard 10, serving as the vehicle protection member, is disposed at a front portion of the suspension member 18. Details of the lower guard 10 will be described later.

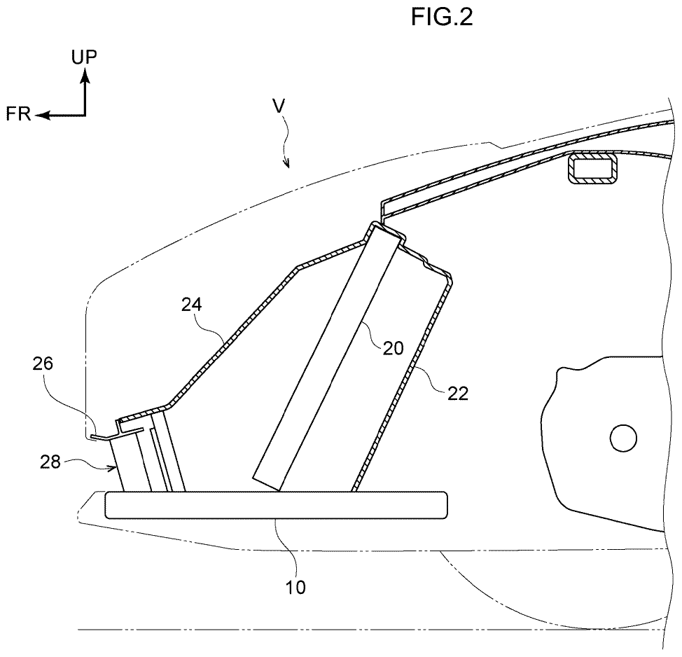

A radiator 20 is disposed between the left and right front side portions 14. FIG. 2 is a schematic side cross-sectional view of the vehicle V. As illustrated in FIG. 2, the radiator 20 is formed in a substantially rectangular shape in side view, and is a member that performs heat exchange due to traveling wind passing through the radiator 20. Further, the radiator 20 of the present exemplary embodiment is fixed in a state in which it is inclined such that a vehicle lower side thereof is positioned further toward a vehicle front than a vehicle upper side thereof, and a rear side of the radiator 20 is covered by a fan shroud 22. The lower guard 10 is attached to a lower end portion of the radiator 20.

A wind guide duct 24 is provided in front of the radiator 20. As illustrated in FIG. 1, a rear end portion of the wind guide duct 24 is a resin member that is formed in a shape following along an outer shape of the radiator 20, and covers a front face of the radiator 20.

Further, the wind guide duct 24 is formed so that a height of a front portion thereof is lower than a height of a rear portion thereof, such that a cross-sectional area of the wind guide duct 24 decreases on progression from the vehicle rear side toward the vehicle front side. Furthermore, a front end portion of the wind guide duct 24 is widened in the vehicle width direction, and is provided with an opening portion 26. Thus, a configuration is provided such that outside air can be introduced from the opening portion 26, and a grill shutter 28 is attached to the opening portion 26.

The grill shutter 28 is formed substantially in a box shape with a vehicle rear side thereof being open, and a rear end portion thereof is attached to the opening portion 26 of the wind guide duct 24. Further, a left and right pair of shutter portions 28A are formed at the grill shutter 28, and when outside air is introduced, the shutter portions 28A are actuated to open a front face of the grill shutter 28. On the other hand, when outside air is not being introduced, the front face of the grill shutter 28 is closed off by the shutter portions 28A.

### (Lower Guard 10)

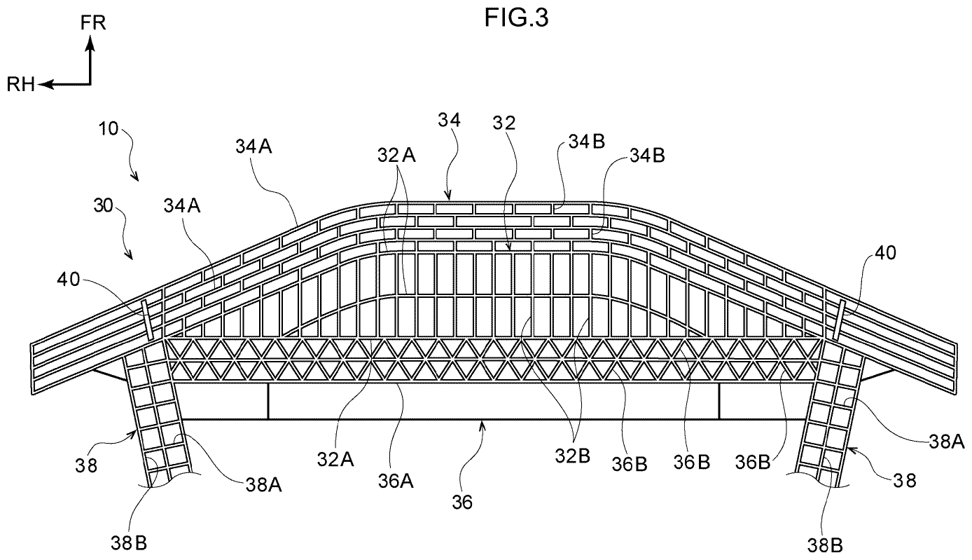

Next, the lower guard 10, which is the main portion of the present disclosure, will be explained. FIG. 3 is a bottom view of the lower guard 10 according to the exemplary embodiment.

As illustrated in FIG. 3, the lower guard 10 of the present exemplary embodiment includes a main body portion 30 having a flat plate shape. The main body portion 30 extends out toward the vehicle front side from the radiator 20, and is configured to include a first reinforcing structure portion 32, a second reinforcing structure portion 34, a radiator support portion 36, and suspension member attachment portions 38.

The first reinforcing structure portion 32 is positioned at a central portion of the main body portion 30, and is configured as a region having a substantially trapezoidal shape in bottom view. In this regard, at the first reinforcing structure portion 32, plural first lateral ribs 32A and plural first longitudinal ribs 32B are formed at a lower face of the main body portion 30.

In the present exemplary embodiment, as an example, three first lateral ribs 32A are provided at a spacing in the vehicle front-rear direction. A first lateral rib 32A at a frontmost portion is a lateral rib configuring a boundary portion between the first reinforcing structure portion 32 and the second reinforcing structure portion 34, and a vehicle width direction central portion thereof extends in a substantially arched shape that bulges toward the vehicle front side.

A first lateral rib 32A at a rearmost portion is a lateral rib configuring a boundary portion between the first reinforcing structure portion 32 and the radiator support portion 36, and extends in a substantially linear shape in the vehicle width direction. Further, both end portions of the first lateral rib 32A at the rearmost portion are connected to both end portions of the first lateral rib 32A at the frontmost portion.

A first lateral rib 32A in the middle extends in the vehicle width direction substantially parallel to the first lateral rib 32A at the frontmost portion, and both end portions thereof are connected to the first lateral rib 32A at the rearmost portion. Thus, the first reinforcing structure portion 32 includes a region surrounded by the first lateral rib 32A at the frontmost portion and the first lateral rib 32A in the middle, and a region surrounded by the first lateral rib 32A at the rearmost portion and the first lateral rib 32A in the middle.

The plural first longitudinal ribs 32B are formed at a spacing in the vehicle width direction, and respectively connect between first lateral ribs 32A that are adjacent to each other in the vehicle front-rear direction. In this regard, positions of first longitudinal ribs 32B that are adjacent to each other in the vehicle front-rear direction with a first lateral rib 32A interposed therebetween coincide with each other. That is to say, the first longitudinal ribs 32B extend in a linear shape from the first lateral rib 32A at the frontmost portion to the first lateral rib 32A at the rearmost portion.

Further, in the first reinforcing structure portion 32, a spacing between the first lateral ribs 32A is greater than a spacing between the first longitudinal ribs 32B. Specifically, the spacing between the first lateral ribs 32A that are adjacent to each other in the vehicle front-rear direction is a spacing that is equal to or greater than twice the spacing between the first longitudinal ribs 32B that are adjacent to each other in the vehicle width direction. Thus, in the first reinforcing structure portion 32, regions that are partitioned by the first lateral ribs 32A and the first longitudinal ribs 32B have substantially rectangular shapes that are long in the vehicle front-rear direction.

The second reinforcing structure portion 34 is provided at a vehicle front side of the first reinforcing structure portion 32. The second reinforcing structure portion 34 is configured as a region having a substantially arched shape in bottom view. In this regard, at the second reinforcing structure portion 34, plural second lateral ribs 34A and plural second longitudinal ribs 34B are formed at the lower face of the main body portion 30.

In the present exemplary embodiment, as an example, four second lateral ribs 34A are provided at a spacing in the vehicle front-rear direction, and a second lateral rib 34A at a rearmost portion is the same rib as the first lateral rib 32A at the frontmost portion of the first reinforcing structure portion 32.

The four second lateral ribs 34A are disposed at regular spacings in the vehicle front-rear direction, and extend substantially parallel to each other. Further, the four second lateral ribs 34A are formed with substantially the same length, and extend further toward vehicle width direction outer sides than the first reinforcing structure portion 32.

Second lateral ribs 34A that are adjacent to each other in the vehicle front-rear direction are connected by second longitudinal ribs 34B that extend in the vehicle front-rear direction. In this regard, the second longitudinal ribs 34B of the present exemplary embodiment are disposed such that positions of second longitudinal ribs 34B that are adjacent to each other in the vehicle front-rear direction with a second lateral rib 34A interposed therebetween are different from each other. Specifically, the second longitudinal ribs 34B are staggered. That is to say, a second longitudinal rib 34B that connects a first second lateral rib 34A and a second second lateral rib 34A from a front end, and a second longitudinal rib 34B that connects a third second lateral rib 34A and a fourth second lateral rib 34A from the front end, are disposed at the same position in the vehicle width direction.

Further, a second longitudinal rib 34B that connects the second lateral rib 34A and the third second lateral rib 34A from the front end is disposed at a position that is offset by a half pitch with respect to the second lateral ribs 34A at the front and rear thereof. Further, in the second reinforcing structure portion 34, a spacing between the second lateral ribs 34A is smaller than a spacing between the second longitudinal ribs 34B. Specifically, the spacing between the second lateral ribs 34A that are adjacent to each other in the vehicle front-rear direction is a spacing that is equal to or less than one half of the spacing between the second longitudinal ribs 34B that are adjacent to each other in the vehicle width direction. Thus, in the second reinforcing structure portion 34, regions that are partitioned by the second lateral ribs 34A and the second longitudinal ribs 34B have substantially rectangular shapes that are long in the vehicle width direction.

Furthermore, the spacing between the second lateral ribs 34A in the second reinforcing structure portion 34 is smaller than the spacing between the first lateral ribs 32A in the first reinforcing structure portion 32, and the spacing between the second longitudinal ribs 34B in the second reinforcing structure portion 34 is greater than the spacing between the first longitudinal ribs 32B in the first reinforcing structure portion 32.

No second longitudinal ribs 34B are formed at both vehicle width direction end portions of the second reinforcing structure portion 34. Specifically, second longitudinal ribs 34B at vehicle width direction outermost ends are respectively formed at positions of both vehicle width direction ends of the first reinforcing structure portion 32. Thus, in the second reinforcing structure portion 34, only the second lateral ribs 34A are formed in regions further toward the vehicle width direction outer sides than the first reinforcing structure portion 32.

In this regard, slits 40 are respectively formed at both vehicle width direction end portions of the second reinforcing structure portion 34. The slits 40 each extend in the vehicle front-rear direction, and the second lateral ribs 34A are notched at portions at which the slits 40 are formed.

The radiator support portion 36, which includes a region in which ribs are disposed in a truss shape in plan view, is provided further toward the vehicle rear side than the first reinforcing structure portion 32. Specifically, the radiator support portion 36 is configured as a substantially rectangular region in bottom view. In this regard, plural third lateral ribs 36A and plural third longitudinal ribs 36B are formed at the lower face of the main body portion 30 in a region at a front side of the radiator support portion 36.

In the present exemplary embodiment, as an example, three third lateral ribs 36A are provided at a spacing in the vehicle front-rear direction, and a third lateral rib 36A at a frontmost portion is the same rib as the first lateral rib 32A at the rearmost portion of the first reinforcing structure portion 32.

The three third lateral ribs 36A are disposed at regular spacings in the vehicle front-rear direction, and extend substantially parallel to each other. Further, the three third lateral ribs 36A are formed to be substantially the same length as each other, and are configured to have lengths that are approximately the same as that of the first reinforcing structure portion 32.

Third lateral ribs 36A that are adjacent to each other in the vehicle front-rear direction are connected by third longitudinal ribs 36B that extend in the vehicle front-rear direction. In this regard, the third longitudinal ribs 36B of the present exemplary embodiment extend obliquely with respect to the vehicle front-rear direction. Specifically, the third longitudinal ribs 36B are disposed at positions that form substantially equilateral triangles between third lateral ribs 36A that are adjacent to the front and rear. Thus, a truss structure is formed by the third lateral ribs 36A and the third longitudinal ribs 36B at the radiator support portion 36.

The lower end portion of the radiator 20 is fixed to an upper face of a region further toward the rear side than the region of the radiator support portion 36 in which the ribs are formed. That is to say, the radiator support portion 36 functions as a radiator support for fixing the radiator 20, and is provided with an attachment portion (not illustrated in the drawings) to which the radiator 20 is attached.

The suspension member attachment portions 38 are provided at both left and right sides of the radiator support portion 36. The suspension member attachment portions 38 are regions that extend in the vehicle front-rear direction, and are attached to the suspension member 18 in a state in which upper faces of the suspension member attachment portions 38 are overlapped with a lower face of the suspension member 18.

Plural fourth lateral ribs 38A and plural fourth longitudinal ribs 38B are formed at the lower face of the main body portion 30 at the suspension member attachment portions 38.

In the present exemplary embodiment, as an example, the plural fourth lateral ribs 38A are provided at a spacing in the vehicle front-rear direction. Further, three fourth longitudinal ribs 38B are provided at a spacing in the vehicle width direction, and the fourth lateral ribs 38A and the fourth longitudinal ribs 38B are formed substantially in a lattice shape.

In the present exemplary embodiment, as an example, in the suspension member attachment portions 38, a spacing between fourth lateral ribs 38A that are adjacent to each other in the vehicle front-rear direction, and a spacing between fourth longitudinal ribs 38B that are adjacent to each other in the vehicle front-rear direction, are substantially the same.

### (Operation)

Next, operation of the lower guard 10 according to the present exemplary embodiment will be explained.

In the present exemplary embodiment, as illustrated in FIGS. 1 to 3, the flat plate-shaped main body portion 30 that is attached to the lower end portion of the radiator 20 is provided, and the main body portion 30 extends out toward the vehicle front side from the radiator 20. Further, lateral ribs and longitudinal ribs are formed at at least one of an upper face or a lower face of the main body portion 30, and the longitudinal ribs connect between adjacent lateral ribs. In this regard, the main body portion 30 includes the first reinforcing structure portion 32 at which positions of first longitudinal ribs 32B that are adjacent to each other in the vehicle front-rear direction with a first lateral rib 32A interposed therebetween coincide with each other. That is to say, in the first reinforcing structure portion 32, since the ribs are disposed with the first lateral ribs 32A and the first longitudinal ribs 32B being in a lattice shape, rigidity of the main body portion 30 is high, and breakage during road surface interference can be suppressed.

Further, the second reinforcing structure portion 34 is provided at the front side of the first reinforcing structure portion 32, and, in the second reinforcing structure portion 34, second longitudinal ribs 34B that are adjacent to each other in the vehicle front-rear direction with a second lateral rib 34A interposed therebetween are disposed such that positions thereof are different. Furthermore, in the first reinforcing structure portion 32, the spacing between the first lateral ribs 32A is greater than the spacing between the first longitudinal ribs 32B, and, in the second reinforcing structure portion 34, the spacing between the second lateral ribs 34A is smaller than the spacing between the second longitudinal ribs 34B. Consequently, in the second reinforcing structure portion 34, since regions surrounded by the second lateral ribs 34A and the second longitudinal ribs 34B in plan view have substantially rectangular shapes with length directions thereof being along the vehicle width direction, and since positions of the second longitudinal ribs 34B at the front and rear are different from each other, the second lateral ribs 34A are more easily deformed to absorb energy when a pedestrian comes in contact therewith, and pedestrian protection performance can be maintained.

Furthermore, in the present exemplary embodiment, the spacing between the second lateral ribs 34A in the second reinforcing structure portion 34 is smaller than the spacing between the first lateral ribs 32A in the first reinforcing structure portion 32. Meanwhile, the spacing between the second longitudinal ribs 34B in the second reinforcing structure portion 34 is greater than the spacing between the first longitudinal ribs 32B in the first reinforcing structure portion 32. Consequently, the second reinforcing structure portion 34 is more easily warped toward the vehicle upper side than the first reinforcing structure portion 32, and pedestrian protection performance is improved.

Moreover, in the present exemplary embodiment, the radiator support portion 36 is provided further toward the vehicle rear side than the first reinforcing structure portion 32, and the radiator support portion 36 is configured such that a truss shape is formed by the third lateral ribs 36A and the third longitudinal ribs 36B in plan view, whereby the radiator support portion 36 can be rigidly configured, and falling-off of the main body portion 30 from the radiator 20 can be suppressed.

Further, in the present exemplary embodiment, the slits 40 are formed at both vehicle width direction end sides of the main body portion 30, thereby enabling a region between the slits 40 to be more easily warped. Specifically, the second reinforcing structure portion 34 positioned between the slits 40 can be easily warped toward the vehicle upper side.

Furthermore, in the second reinforcing structure portion 34, since the second longitudinal ribs 34B are not provided in the regions further toward the vehicle width direction outer sides than the slits 40, these regions can absorb collision energy by being actively crushed in the vehicle front-rear direction at the time of a collision.

Although the vehicle protection member according to the present disclosure has been described above, it goes without saying that various embodiments can be implemented within a range that does not depart from the spirit of the present disclosure. For example, in the present exemplary embodiment, although the lateral ribs and the longitudinal ribs are formed at the lower face of the main body portion 30, there is no limitation thereto, and the lateral ribs and the longitudinal ribs may be formed at the upper face of the main body portion 30. Furthermore, the lateral ribs and the longitudinal ribs may be formed at both of the lower face and the upper face of the main body portion 30.

Further, in the present exemplary embodiment, although the slits 40 are formed at both vehicle width direction end portions of the main body portion 30, there is no limitation thereto, and a structure in which the slits 40 are not formed may be employed. Alternatively, another fragile structure may be provided in place of the slits 40. For example, some of the second lateral ribs 34A in the second reinforcing structure portion 34 may be configured to have a lower height to thereby make them more fragile than other second lateral ribs 34A.

Furthermore, in the present exemplary embodiment, although the radiator support portion 36 is provided at the vehicle rear side of the first reinforcing structure portion 32, there is no limitation thereto, and a structure in which a radiator support portion is not provided may be employed. Alternatively, a structure in which a radiator support portion is provided as a separate body may be employed.

With regard to the above-described exemplary embodiment, the following additional notes are further disclosed.

### (Additional Note 1)

A vehicle protection member including:
a flat plate-shaped main body portion that is attached to a lower end portion of a radiator and that extends out toward a vehicle front side from the radiator;
plural lateral ribs that are provided at at least one of an upper face or a lower face of the main body portion, that are formed at a spacing in a vehicle front-rear direction, and that each extend in a vehicle width direction; and
plural longitudinal ribs that are formed at a spacing in the vehicle width direction and that each extend in the vehicle front-rear direction to connect between adjacent lateral ribs,
wherein:
the main body portion includes a first reinforcing structure portion at which positions of longitudinal ribs that are adjacent to each other in the vehicle front-rear direction with a lateral rib interposed therebetween coincide with each other, and a second reinforcing structure portion that is disposed at a front side of the first reinforcing structure portion such that positions of longitudinal ribs that are adjacent to each other in the vehicle front-rear direction with a lateral rib interposed therebetween are different from each other,
in the first reinforcing structure portion, a spacing between the lateral ribs is greater than a spacing between the longitudinal ribs, and
in the second reinforcing structure portion, a spacing between the lateral ribs is smaller than a spacing between the longitudinal ribs.

### (Additional Note 2)

The vehicle protection member according to Additional Note 1, wherein:
the spacing between the lateral ribs in the second reinforcing structure portion is smaller than the spacing between the lateral ribs in the first reinforcing structure portion, and
the spacing between the longitudinal ribs in the second reinforcing structure portion is greater than the spacing between the longitudinal ribs in the first reinforcing structure portion.

### (Additional Note 3)

The vehicle protection member according to Additional Note 1 or Additional Note 2, wherein a radiator support portion at which ribs are disposed in a truss shape in plan view is provided further toward a vehicle rear side than the first reinforcing structure portion, and the radiator is attached to the radiator support portion.

### (Additional Note 4)

The vehicle protection member according to any one of Additional Note 1 to Additional Note 3, wherein slits are respectively formed at both vehicle width direction end sides of the main body portion.

What is claimed is:

1. A vehicle protection member comprising:
a flat plate-shaped main body portion that is attached to a lower end portion of a radiator and that extends out toward a vehicle front side from the radiator;
a plurality of lateral ribs that are provided at at least one of an upper face or a lower face of the main body portion, that are formed at a spacing in a vehicle front-rear direction, and that each extend in a vehicle width direction; and
a plurality of longitudinal ribs that are formed at a spacing in the vehicle width direction and that each extend in the vehicle front-rear direction to connect between adjacent lateral ribs,
wherein:
the main body portion includes a first reinforcing structure portion at which positions of longitudinal ribs that are adjacent to each other in the vehicle front-rear direction with a lateral rib interposed therebetween coincide with each other, and a second reinforcing structure portion that is disposed at a front side of the first reinforcing structure portion such that positions of longitudinal ribs that are adjacent to each other in the vehicle front-rear direction with a lateral rib interposed therebetween are different from each other,
in the first reinforcing structure portion, a spacing between the lateral ribs is greater than a spacing between the longitudinal ribs, and
in the second reinforcing structure portion, a spacing between the lateral ribs is smaller than a spacing between the longitudinal ribs.

2. The vehicle protection member according to claim 1, wherein:
the spacing between the lateral ribs in the second reinforcing structure portion is smaller than the spacing between the lateral ribs in the first reinforcing structure portion, and
the spacing between the longitudinal ribs in the second reinforcing structure portion is greater than the spacing between the longitudinal ribs in the first reinforcing structure portion.

3. The vehicle protection member according to claim 1, wherein a radiator support portion including a region in which ribs are disposed in a truss shape in plan view is provided further toward a vehicle rear side than the first reinforcing structure portion, and the radiator is attached to the radiator support portion.

4. The vehicle protection member according to claim 1, wherein slits are respectively formed at both vehicle width direction end sides of the main body portion.
